(19) United States
(12) Patent Application Publication
(10) Pub. No.: US 2023/0200371 A1
(43) Pub. Date: Jun. 29, 2023

(54) ANTI-TORSION RODENT TRAP SYSTEM AND KIT

(71) Applicant: Bruno A. Nardelli, Watertown, MA (US)

(72) Inventor: Bruno A. Nardelli, Watertown, MA (US)

(21) Appl. No.: 18/081,570

(22) Filed: Dec. 14, 2022

Related U.S. Application Data
(60) Provisional application No. 63/293,493, filed on Dec. 23, 2021.

(51) Int. Cl. A01M 23/24

(52) U.S. Cl. CPC A01M 23/245

(57) ABSTRACT

An anti-torsion system and kit for spring-powered rodent traps. The system and kit make use of one or more torsion-blockers. Each torsion-blocker includes a substrate having a first surface and a second surface opposite the first surface, a first fastening mechanism on the first surface of the substrate attaching the torsion-blocker to the base of the rodent trap, and a second fastening mechanism on the second surface of the substrate attaching the torsion-blocker to a surface upon which the rodent trap base rests. When a rodent trap is mounted using the system, the one or more torsion-blockers oppose the torsion force and prevents the twisting movement of the rodent trap base caused by the acceleration and snapping down of the hammer motivated by the spring from occurring.

### CROSS-REFERENCE TO RELATED APPLICATION(S)

This application claims priority to, and the benefit of, co-pending U.S Provisional Application 63/293,493, filed Dec. 23, 2021, for all subject matter contained therein. The disclosure of said provisional application is hereby incorporated by reference in its entirety.

### FIELD OF THE INVENTION

The present invention relates to anti-torsion systems and kits thereof. In particular, the present invention relates to systems and kits making use of one or more torsion-blockers that oppose the torsion force and prevent the twisting movement of the base of the rodent trap caused by the activation of the hammer motivated by the spring of the rodent trap.

### BACKGROUND

An example of a conventional spring-powered rodent trap can be seen in FIG. 1. Here, the spring-powered rodent trap 102 involves a base 104, a spring 106, and a hammer 108 motivated by the spring 106. The hammer 108 is held under tension in a loaded position by a bar 116 that is held in place by the latch trip mechanism 114 of the trigger 110. Bait is placed on an end 112 of the trigger 110 to attract a rodent 100. When the rodent 100 engages the trigger 110, the trigger 110 releases the latch trip mechanism 114 and the bar 116, and the spring 106 motivates the hammer 108 to quickly accelerate and move in a snapping manner toward a hammer-down position. Ideally, the hammer 108 moves quickly enough to the hammer-down position where it strikes the rodent 100 that triggered the rodent trap 102.

However, such known spring-powered rodent traps experience some shortcomings. A major cause of the failure of such conventional spring-powered rodent traps to capture rodent prey is due to the motion of the base of the trap that results from the spring leveraged hammer accelerating and rotating or pivoting toward the closed, hammer-down, position. An Example of this can be seen in FIG. 2. When tripped, the trap base 104 experiences torsional forces that result in rotating and/or twisting the base 104 in the direction as indicated by arrow 200 to meet the oncoming hammer 108 rotating/pivoting as indicated by arrow 202 in the opposite direction. This movement of the base 104 opposite to the forces created by the acceleration and rotation of the hammer 108 are well-understood by those of skill in the art (see Newton’s Third Law of Motion commonly discussed as Action and Reaction: Whenever one object exerts a force on another object, the second object exerts an equal and opposite force on the first), thus obviating the need for any further explanation. Sensing this motion of the base 104, the rodent 100 often reacts by withdrawing from the trap as indicated by arrow 204. In addition, the motion indicated by arrow 200 of the base 104 can move the base away from the rodent, thus resulting in the rodent 100 being outside of striking range of the hammer 108 in its hammer-down position. Despite the existence of the conventional spring-powered rodent traps for many years, this shortcoming has not been adequately addressed, and thus there is a long-felt need for a solution to prevent the torsional movement of the trap.

### SUMMARY

There is a need for a means to prevent this torsional movement of a rodent trap during activation. The present invention is directed toward further solutions to address this need, in addition to having other desirable characteristics. Specifically, the present invention provides an anti-torsion system and kit for conventional spring-powered rodent traps as described above. The system and kit make use of one or more torsion-blockers that attach a base of the rodent trap to a surface upon which the rodent trap base rests. Each torsion-blocker includes a substrate having a first surface and a second surface opposite the first surface, a first fastening mechanism on the first surface of the substrate attaching the torsion-blocker to the base of the rodent trap, and a second fastening mechanism on the second surface of the substrate attaching the torsion-blocker to a surface upon which the rodent trap base rests. When the rodent trap is mounted using the system or kit, the one or more torsion-blockers oppose the torsion force and prevent the twisting movement of the rodent trap base caused by the spring-powered acceleration and snapping of the hammer to the hammer-down position from occurring.

The solution provided by the present invention is an anti-torsion system and kit for spring-powered rodent traps as described in the Detailed Description, Figures, and Claims, which are fully incorporated into this Summary section

### BRIEF DESCRIPTION OF THE FIGURES

These and other characteristics of the present invention will be more fully understood by reference to the following detailed description in conjunction with the attached drawings, in which:

FIG. 1 depicts a conventional spring-powered rodent trap;

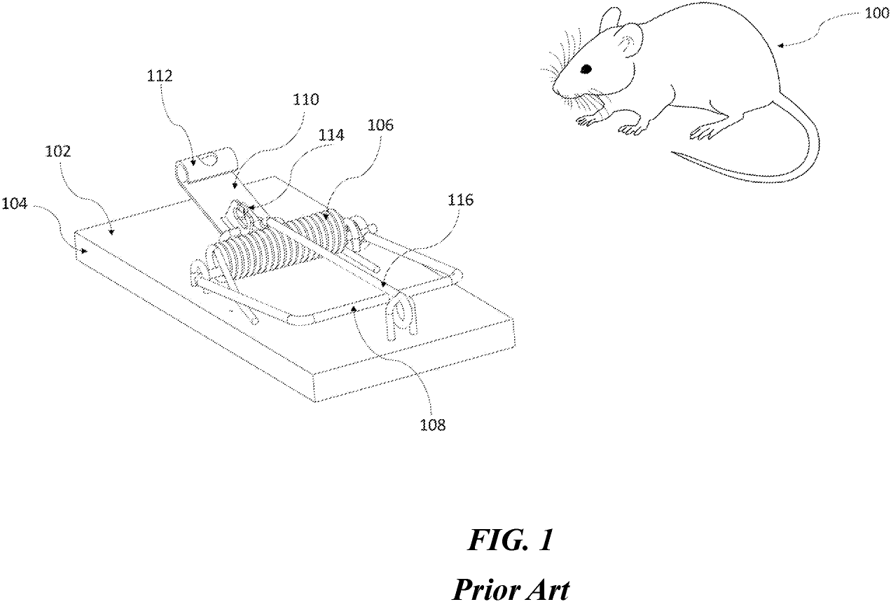

FIG. 2 depicts the operation and shortcomings of conventional spring-powered rodent traps;

FIG. 3 is a side view of an anti-torsion rodent trap system or kit utilized with embodiments of the present invention;

FIG. 4 is a front left isometric view of the system or kit utilizing a single torsion-blocker on a bottom of a base of a rodent trap in accordance with aspects of the present invention;

FIG. 5 is an exploded view of the system or kit of FIG. 4;

FIG. 6 is a front left isometric view of the system or kit utilizing multiple torsion-blocker on the bottom of the base of the rodent trap in accordance with aspects of the present invention;

FIG. 7 is an exploded view of the system or kit of FIG. 6;

FIG. 8 is a front left isometric view of a system or kit utilizing multiple torsion-blockers on sides of the base of the rodent trap in accordance with aspects of the present invention;

FIG. 9 is an exploded view of the mounting system of FIG. 8;

FIG. 10 is an exploded view of an example kit in accordance with aspects of the present invention; and

FIG. 11 depicts how the one or more torsion-blockers of the system or kit oppose the torsional forces and prevent twisting of the base in accordance with aspects of the present invention.

### DETAILED DESCRIPTION

An illustrative embodiment of the present invention relates to an anti-torsion system and corresponding kit for spring-powered rodent traps. The system makes use of one or more torsion-blockers. Each torsion-blocker includes a substrate having a first surface and a second surface opposite the first surface, a first fastening mechanism on the first surface of the substrate attaching the torsion-blocker to the base of the rodent trap, and a second fastening mechanism on the second surface of the substrate attaching the torsion-blocker to a surface upon which the rodent trap base rests. When a rodent trap is mounted using the system, the one or more torsion-blockers oppose the torsion force and prevent the twisting movement of the rodent trap base from occurring that is otherwise caused by the spring-powered acceleration and snapping down of the hammer to the hammer-down position.

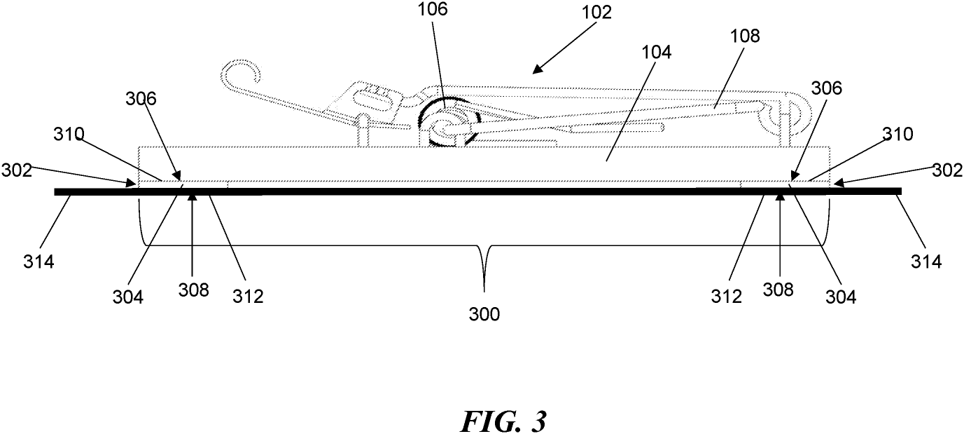

FIG. 3 through FIG. 11 wherein like parts are designated by like reference numerals throughout, illustrate an example embodiment or embodiments of an anti-torsion system for spring-powered rodent traps, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

As seen in FIG. 3, the system 300 of the present invention includes one or more torsion-blockers 302. Each torsion-blocker 302 includes a substrate 304 having a first surface 306 and a second surface 308 opposite the first surface. A first fastening mechanism 310 is provided on the first surface 306 of the substrate 304 attaching the torsion-blocker 302 to the base 104 of the rodent trap 102. A second fastening mechanism 312 is provided on the second surface 308 of the substrate 304 attaching the torsion-blocker 302 to a surface 314 upon which the rodent trap base 104 rests.

The substrate 304 provides the structure and support for the first fastening mechanism 310 and second fastening mechanism 312, enabling the torsion-blocker 302 to attach to the base 104 of the rodent trap 102 and the surface 314 on which the base 104 is placed. As such, the structure of the substrate 304 can contribute to the functionality of the torsion-blocker 302 by providing force dampening or resisting characteristics and/or enhancing the fastening mechanisms 310, 312 by working in conjunction with a particular type of fastening mechanism. The substrate 304 is configured to provide this functionality while being significantly thin enough so as to not place the rodent trap 102 at an impractical or non-functional distance off of the surface 314. The substrate 304 can be formed of one or more of plastic, foam, paper, cardboard, rubber, silicone, metal, or the like. Other suitable materials or combinations of materials will be apparent to one skilled in the art given the benefit of this disclosure.

The first fastening mechanism 310 is provided on the first surface 306 for attaching the torsion-blocker 302 to the base 104 of the rodent trap 102. The first fastening mechanism 310 comprises one or more of: adhesive, hook and loop fasteners, magnets, suction devices, mechanical fasteners, or the like. Other suitable fastening means will be apparent to one skilled in the art given the benefit of this disclosure and with full functionality and operability to that of the described invention are considered equivalent.

The second fastening mechanism 312 is provided on the second surface 308 for attaching the torsion-blocker 302 to a surface 314. The second fastening mechanism 312 comprises one or more of: adhesive, hook and loop fasteners, magnets, suction devices, mechanical fasteners, or the like. In certain embodiments, the second fastening mechanism 312 allows for re-positioning of the rodent trap 102 on the surface 314. Other suitable fastening means will be apparent to one skilled in the art given the benefit of this disclosure and with full functionality and operability to that of the described invention are considered equivalent.

It should be understood that the substrate 304 is configured to work in conjunction with the fastening mechanism 310, 312 used. Thus, for example, in one example embodiment where the one or more of the fastening mechanisms 310, 312 are magnets, the substrate 304 is formed of a magnetic material. In cases wherein the one or more of the fastening mechanisms 310, 312 are suction devices, the substrate 304 can be formed of the same material at the suction devices, such a rubber, silicone, or plastic. Other possible configurations will be apparent to one skilled in the art given the benefit of this disclosure and with full functionality and operability to that of the described invention are considered equivalent.

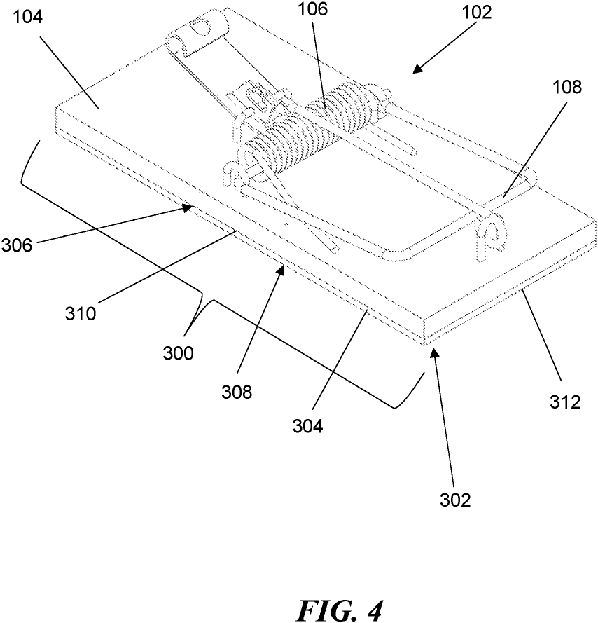

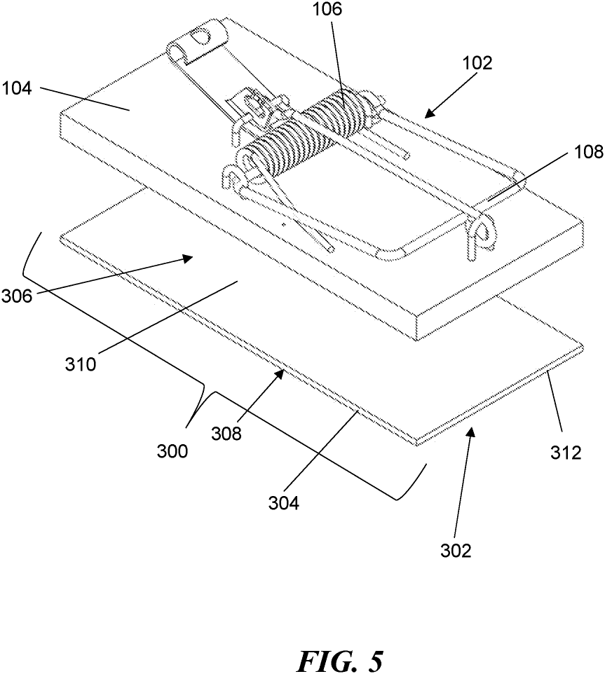

FIG. 4 and FIG. 5 depict one example embodiment of the system 300 in which there is a single torsion-blocker 302 that covers a substantial portion of the bottom of the base 104 of the rodent trap 102. FIG. 4 depicts the torsion-blocker 302 of the system 300 attached to and entirely covering the bottom of the base 104 of the rodent trap 102. FIG. 5 is an exploded view showing the system 300 separated from the rodent trap 102.

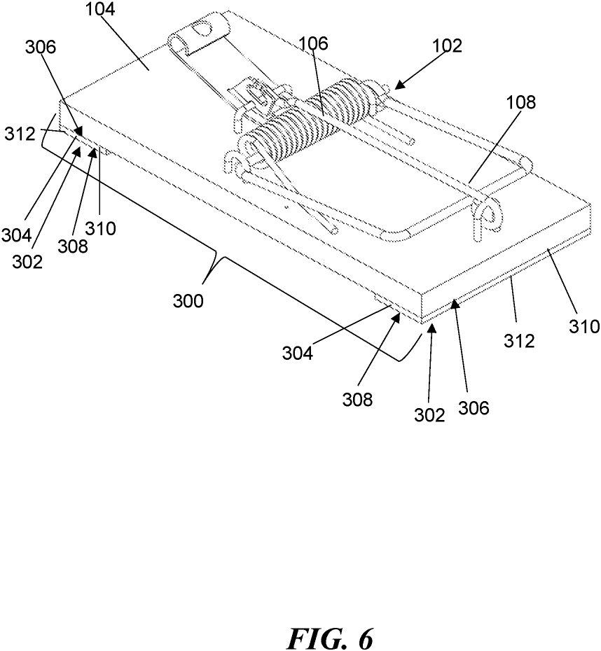

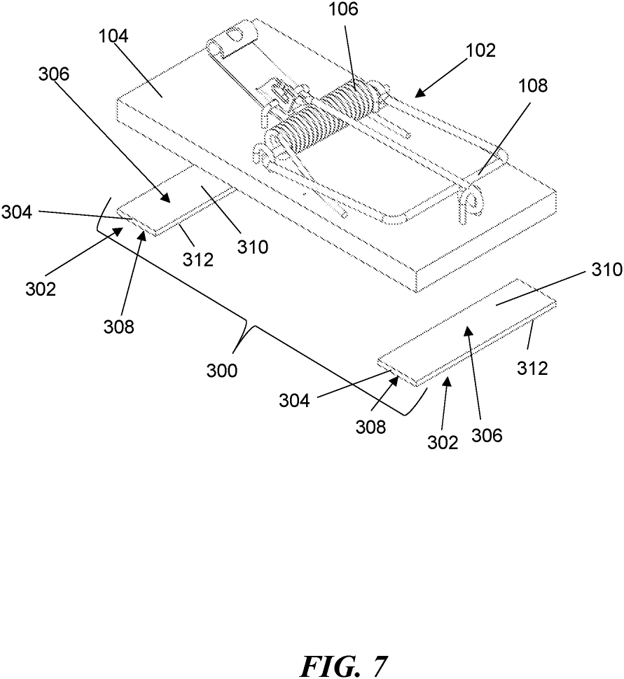

FIG. 6 and FIG. 7 depict another example embodiment of the system 300 in which there are a plurality of torsion-blockers 302 attached to the bottom of the base 104 of the rodent trap 102 along the short edges of the base. FIG. 6 depicts the torsion-blockers 302 of the system 300 attached to the periphery of the bottom of the base 104 of the rodent trap 102. FIG. 7 is an exploded view showing the system 300 separated from the rodent trap 102. It should be understood that the position and number of torsion-blockers 302 on the bottom of the base can vary.

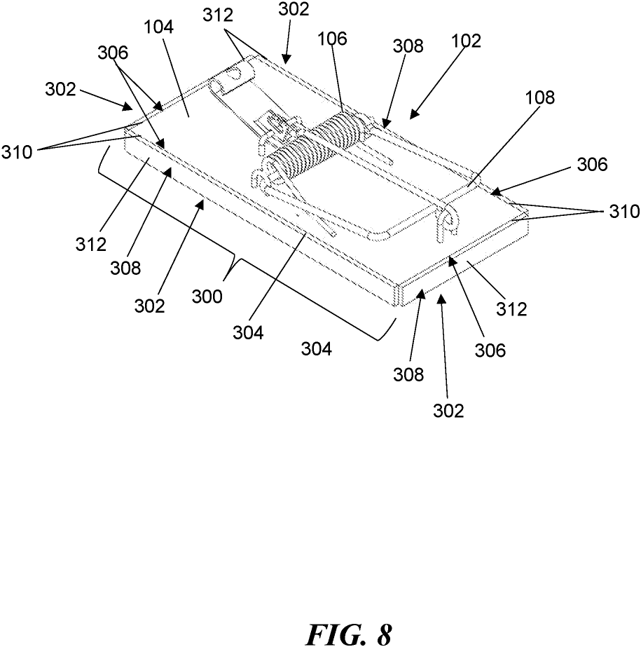

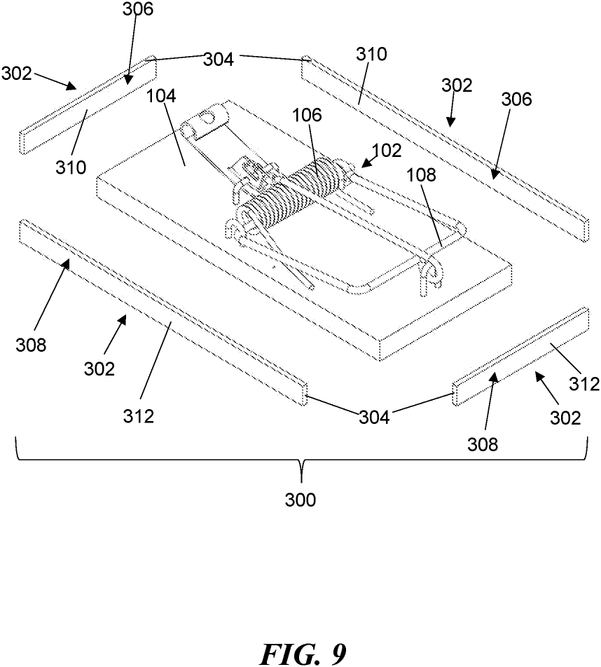

FIG. 8 and FIG. 9 depict another embodiment of the system 300 in which one or more torsion-blockers 302 are attached to one or more sides of the base 104 of the rodent trap 102. FIG. 8 depicts the torsion-blockers 302 of the system 300 attached to each side of the base 104 of the rodent trap 102. FIG. 9 is an exploded view showing the system 300 separated from the rodent trap 102. It should be understood that any number of torsion-blockers 302 can be applied to any number of sides of the base 104.

In each of the embodiments described herein regarding the structure, configuration, and placement of the one or more torsion-blockers 302, the specific configuration utilized will depend on the surrounding environment of the rodent trap 102. Specifically, when there is a relatively smooth and clean flat surface such as surface 314 in FIG. 3, the configuration of FIGS. 6 and 7 is likely sufficient to provide the necessary anti-torsion operation to prevent or substantially dampen the rodent trap 102 from undesired twisting movement. When there is a relatively rough or unclean surface 314 (e.g., such as rough wood, carpet, or the like) a larger torsion-blocker 302 surface area may be required, and thus a configuration such as shown in FIGS. 4 and 5 are recommended. When the rodent trap 102 can be placed against a wall or corner, one or more of the torsion-blockers are placed on the sides of the rodent trap 102 as depicted in FIGS. 8 and 9 are recommended. One of skill in the art will appreciate that the system 300 of the present invention is designed with these aforementioned alternative configurations and other equivalents with the requirement that the one or more torsion-blocker 302 configurations utilized in a particular environment and placement of a rodent trap 102 be suitable to enable contact and mechanical or magnetic or other coupling by the one or more torsion-blockers 302 with the surface 314 (including floors/walls/corners/etc.) and the base 104 of the rodent trap 102 in such a way that results in the anti-torsion functionality described herein. One of skill in the art will further appreciate that some variation of placement of the one or more torsion-blockers 302 between the rodent trap 102 and the surface 314 (including floors/walls/corners/etc.) beyond that specifically shown in the example illustrations is expected and considered to be consistent with, and anticipated by, the teachings of the present invention and disclosure.

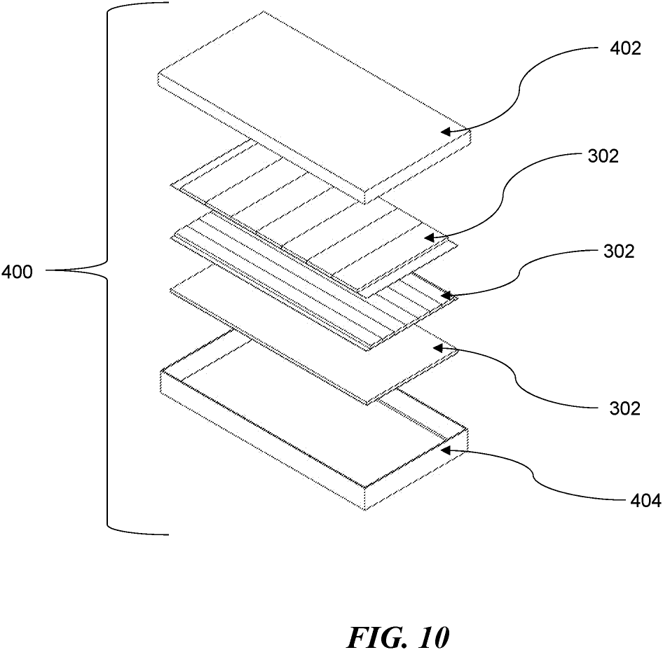

In certain embodiments, the one or more torsion-blockers 302 of the system 300 may be provided as a kit 400, an example of which is seen in FIG. 10 in an exploded view, wherein the one or more torsion-blockers 302 are provided for use with a rodent trap 102 in any of the configurations described above. In some such, embodiments, the kit may include any or all of the types of styles of torsion-blocker 302 with any or all of the types of fastening mechanisms 310, 312 described. The example kit 400 of FIG. 10 includes all the versions of torsion-blockers 302 disclosed and discussed in relation to FIGS. 4-9. Here, all the included torsion-blockers 302 are packaged in a box having a cover 402 and base 404. It should be understood that other types of packaging and content configuration can be used, and also that multiple substrates of multiple shapes and sizes can be included in a single bag or box to form the kit 400. In certain aspects, the kit may further include a set of instructions providing guidance for the placement of torsion-blockers 302 (as well as fastening mechanisms 310, 312) that is best suited for the desired installation to achieve or facilitate the desired anti-torsion effect such that when the hammer 108 motivated by the spring 106 is activated, the hammer 108 accelerates and snaps down, causing a torsion force acting on the rodent trap base 104 and the one or more torsion-blocker 302 opposes the torsion force and prevents a twisting movement of the rodent trap base 104 from occurring.

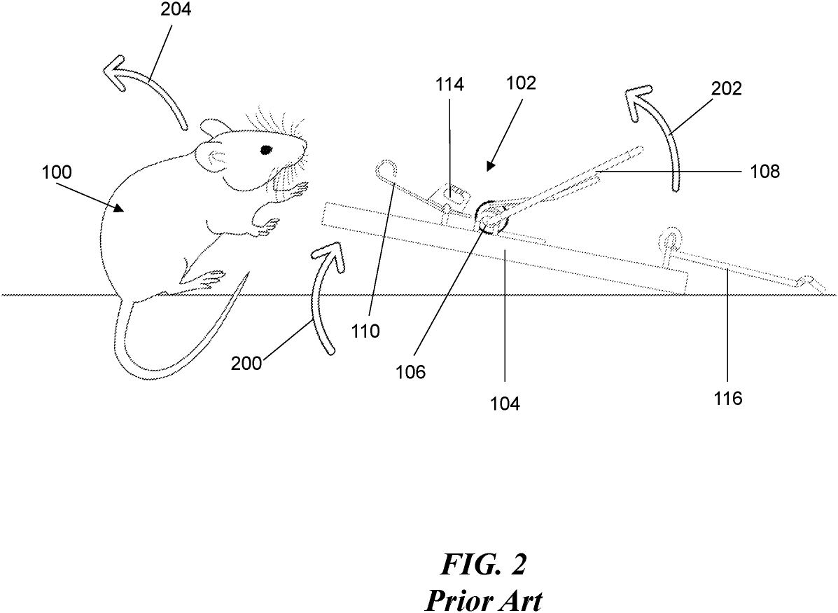

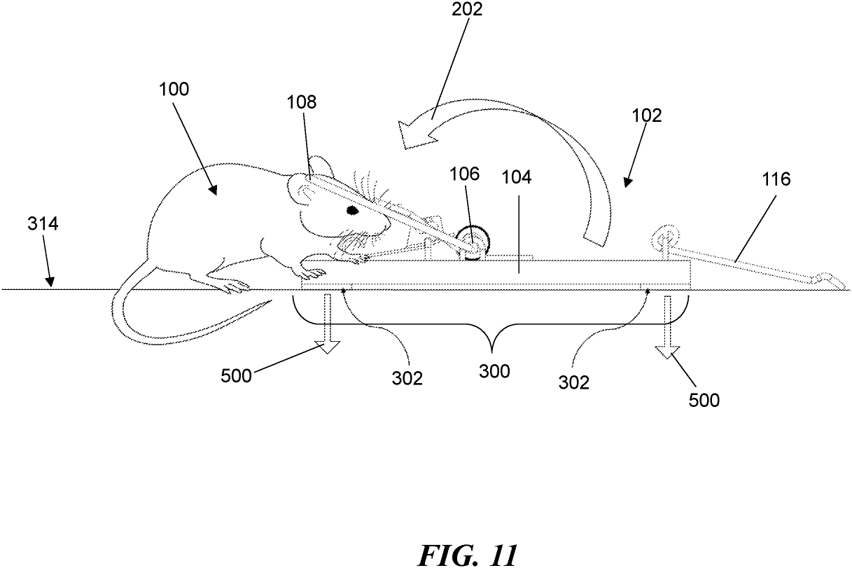

FIG. 11 depicts how the one or more torsion-blockers 302 of the system 300 oppose the torsional force and prevent the twisting movement of the base 104 of the rodent trap 102 when the trap 102 is triggered. As discussed previously in regard to FIG. 2, when the hammer 108 motivated by the spring 106 is activated, the hammer 108 accelerates and snaps down in the direction of arrow 202 to a hammer-down position causing a torsion force 200 acting on the base 104. However, with the use of the inventive system 300, the one or more torsion-blockers 302 create a counterforce indicted by arrows 500 that opposes, counteracts, and/or cancels the torsion force 200 that would normally occur. This also prevents the movement of the base 104 allowing the rodent trap 102 to be more effective in capturing the rodent 100.

To any extent utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about” and “approximately” are intended to cover variations that may exist in the upper and lower limits of the ranges of subjective or objective values, such as variations in properties, parameters, sizes, and dimensions. In one non-limiting example, the terms “about” and “approximately” mean at, or plus 10 percent or less, or minus 10 percent or less. In one non-limiting example, the terms “about” and “approximately” mean sufficiently close to be deemed by one of skill in the art in the relevant field to be included. As utilized herein, the term “substantially” refers to the complete or nearly complete extent or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near-complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification, embodiments have been described in a way that enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. An anti-torsion rodent trap system for a spring-powered rodent trap having a base, a spring, and a hammer motivated by the spring, the system comprising:
one or more torsion-blockers, each torsion-blocker comprising:
a substrate having a first surface and a second surface opposite the first surface;
a first fastening mechanism on the first surface of the substrate attaching the torsion-blocker to the base of the rodent trap; and
a second fastening mechanism on the second surface of the substrate attaching the torsion-blocker to a surface upon which the rodent trap base rests;
wherein when the hammer motivated by the spring is activated, the hammer accelerates and snaps down, causing a torsion force acting on the rodent trap base; and
wherein the one or more torsion-blockers oppose the torsion force and prevent a twisting movement of the rodent trap base from occurring.

2. The system of claim 1, wherein the one or more torsion-blockers are attached to a bottom surface of the base of the rodent trap.

3. The system of claim 2, wherein the one or more torsion-blockers comprise a single torsion-blocker covering a substantial portion of the bottom of the base of the rodent trap.

4. The system of claim 2, wherein the one or more torsion-blocker comprise a plurality of torsion-blockers each attached to a periphery of the bottom of the base of the rodent trap.

5. The system of claim 1, wherein the one or more torsion-blockers are attached to one or more edges of the base of the rodent trap.

6. The system of claim 1, wherein the first fastening mechanism comprises one or more of: adhesive, hook and loop fasteners, magnets, suction devices, and mechanical fasteners.

7. The system of claim 1, wherein the second fastening mechanism comprises one or more of: adhesive, hook and loop fasteners, magnets, suction devices, and mechanical fasteners.

8. The system of claim 7, wherein the second fastening mechanism allows for re-positioning of the rodent trap.

9. The system of claim 1, wherein the substrate comprises one or more of: plastic, foam, paper, cardboard, rubber, silicone, and metal.

10. A kit for an anti-torsion rodent trap system for a spring-powered rodent trap having a base, a spring, and a hammer motivated by the spring, the kit comprising:
one or more torsion-blockers, each torsion-blocker comprising:
a substrate having a first surface and a second surface opposite the first surface;
a first fastening mechanism on the first surface of the substrate attaching the torsion-blocker to the base of the rodent trap; and
a second fastening mechanism on the second surface of the substrate attaching the torsion-blocker to a surface upon which the rodent trap base rests.

11. The kit of claim 10, further comprising a set of instructions providing guidance on placement of the one or more torsion-blockers on the rodent trap.

12. The kit of claim 11, wherein the guidance on placement of the one or more torsion-blockers facilitates operability in such a way that when the hammer motivated by the spring is activated, the hammer accelerates and snaps down, causing a torsion force acting on the rodent trap base and the one-or more torsion-blocker opposes the torsion force and prevents a twisting movement of the rodent trap base from occurring.

13. The kit of claim 10, wherein the one or more torsion blockers are packaged in a container.
